(19) United States
(12) Patent Application Publication
(10) Pub. No.: US 2026/0277716 A1
(43) Pub. Date: Sep. 17, 2026

(54) SYSTEM FOR PROVIDING PERSONALIZED APPLICATION PROGRAMMING INTERFACE EXPERIENCE

(71) Applicant: SoftBank Group Corp., Tokyo (JP)

(72) Inventor: Akinori MACHIDA, Tokyo (JP)

(21) Appl. No.: 19/562,807

(22) Filed: Mar. 11, 2026

Related U.S. Application Data
(60) Provisional application No. 63/772,746, filed on Mar. 17, 2025.

(51) Int. Cl. G06F 9/54; H04L 51/21

(52) U.S. Cl. CPC G06F 9/547; H04L 51/21

(57) ABSTRACT

A system that builds an individual natural language processing model and provides a personalized experience for a customer using an application programming interface connection. A pre-trained base model is prepared on a server, and text data is collected from the customer's messaging apps, emails, and social networking services on a terminal. The collected data is used to learn the language usage patterns and preferences of each customer on the server and generate an individual model.

### CROSS-REFERENCE TO RELATED APPLICATIONS

This application is based upon and claims the benefit of priority from U.S. Provisional Patent Application No. 63/772,746, filed on Mar. 17, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to provide a personalized experience for each customer. Although conventional natural language processing systems have general language understanding capabilities, there has been a problem in that it is difficult to respond to the specific needs and preferences of individual users. As a result, users often felt dissatisfied that their intentions were not accurately understood or that they could not receive information or suggestions that matched their preferences.

Furthermore, the protection of personal information and privacy issues are also important problems. Since many systems extensively collect user data and may provide it to third parties, users cannot fully grasp how their information is being used and may feel anxious.

A personalized experience that reflects a customer's language usage patterns and preferences is provided by building an individual natural language processing model based on interactions on the customer's mobile phone, using a natural language processing model that has undergone base learning in advance. In addition, since the customer can manage the Application Programming Interface (API) connection to their own natural language processing model, it also addresses the problems of personal information protection and privacy. This allows the customer to enjoy more convenient and efficient services while controlling how their information is used.

Disclosed herein is a system having the following configuration. First, a base learning unit is provided that prepares a natural language processing model that has undergone base learning in advance. This base learning unit is trained to have general language understanding capabilities using a wide range of text datasets, and can understand basic grammatical structures and the meanings of vocabulary.

Next, a data collection unit is provided that inputs all interactions on a customer's mobile phone in an environment where complete security on the network side is ensured. This data collection unit, with the customer's permission, collects text data such as conversations in messaging apps, emails, and posts on Social Networking Services (SNS), and provides information for reflecting the customer's language usage patterns and communication style in detail.

Furthermore, an individual learning unit is provided that builds a natural language processing model for each customer using the collected data. This individual learning unit uses machine learning algorithms to learn the customer's language usage patterns, preferences, interests, values, and the like, and generates a customized natural language processing model that reflects them. This model has the ability to anticipate what the customer is “likely to think” and provides a personalized experience according to the customer's individual needs.

Finally, a connection management unit is provided that allows the customer to manage the API connection to their own natural language processing model. This connection management unit allows the customer to set “permission” or “denial” for applications that use their own natural language processing model. This allows the customer to protect their personal information and privacy while allowing specific applications to use their natural language processing model as needed. In this way, the customer can enjoy more convenient and efficient services while controlling how their information is used.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method of providing a personalized experience.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

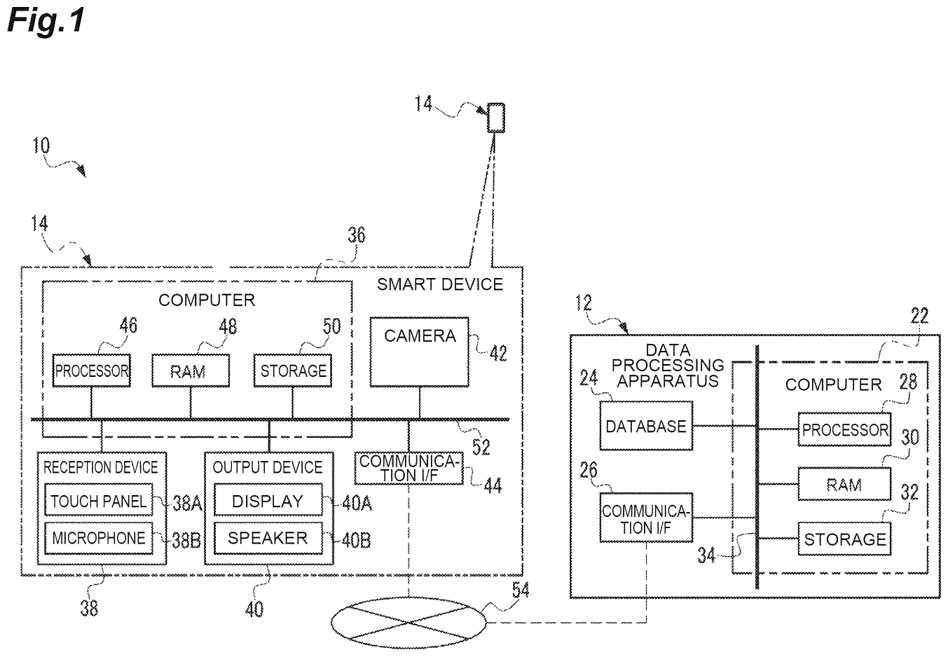

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

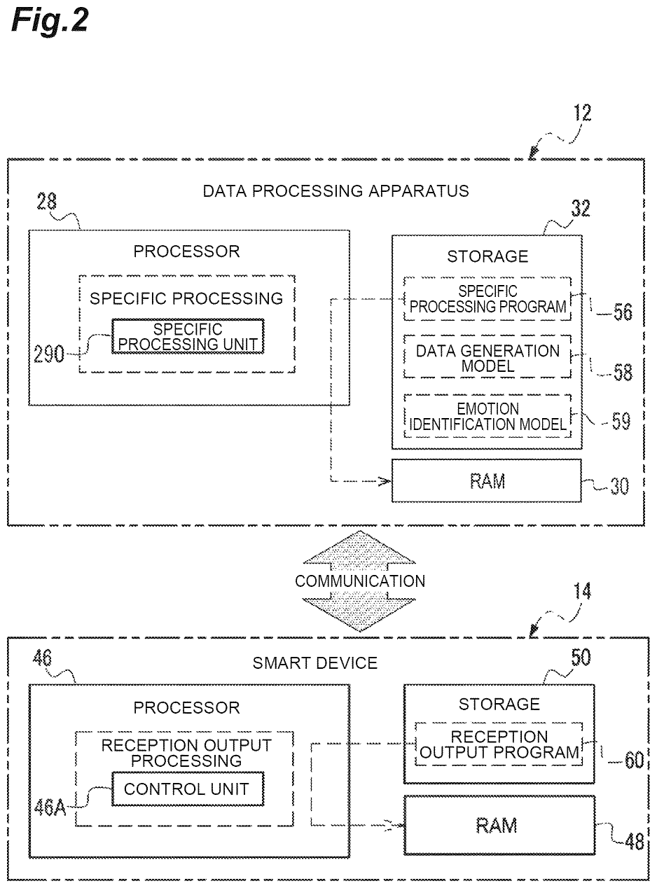

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

This system is realized by both a server and a terminal, and each unit plays its respective role.

First, the base learning unit is realized on a server. This server holds a natural language processing model that has been pre-trained using a wide range of text datasets. This model has the ability to understand general grammatical structures and the meanings of vocabulary, and is trained, for example, using data collected from various sources such as news articles, encyclopedias, and literary works. This provides the model with a foundation for understanding diverse contexts and expressions.

The natural language processing model in the base learning unit may include, for example, a neural network based on a Transformer architecture (e.g., BERT, GPT, or derivatives thereof). This model includes a multi-layer Self-Attention mechanism and learns context dependencies of input text data through parallel processing. Here, the base-learned model has hundreds of millions to trillions of parameters, but in the individual learning described later, weight parameters of the base model may be fixed (frozen), and an additional adapter layer (Adapter Layer) or a low-rank matrix (Low-Rank Adaptation: LoRA) may be a learning target. Thereby, in the storage 32 and the memory (RAM 30) on the server, it becomes unnecessary to individually hold huge models for a large number of customers, and by holding only difference parameters for each customer while sharing the weights of the base model, memory usage is dramatically reduced (for example, to 1/100 or less), and efficient use of calculation resources becomes possible.

The base learning unit may be configured by, for example, the computer 22 (processor 28, etc.) of the data processing apparatus 12, or may be configured by the specific processing unit 290, the specific processing program 56, the data generation model 58, and the like.

Next, the data collection unit is realized on a terminal. The terminal, with the customer's permission, collects text data from messaging apps, email clients, SNS apps, and the like. For example, the content of conversations in a messaging app that a customer uses on a daily basis includes interactions with friends and family, business communications, and the like. From the email client, the history of sending and receiving business emails and personal emails is collected. From the SNS app, comments posted by the customer, reactions to others' posts, history of likes and shares, and the like are included. This data serves as an important source of information for reflecting the customer's language usage patterns and communication style in detail.

The data collection unit may be configured by, for example, the computer 36 (processor 46, etc.) of the smart device 14, or may be configured by the control unit 46A, the reception output program 60, and the like.

The collected data is processed by an individual learning unit on the server. This unit uses machine learning algorithms to learn the customer's language usage patterns, preferences, interests, values, and the like. For example, it identifies phrases and words frequently used by the customer and analyzes their frequency of use and context. It also analyzes patterns of reactions and emotional expressions to specific topics and incorporates the customer's emotional tendencies into the model. As a result, an individual natural language processing model for the customer is generated, which has the ability to anticipate what the customer is “likely to think”. This model provides a personalized experience according to the customer's needs based on the customer's past behavior and language patterns.

The individual learning unit may be configured by, for example, the computer 22 (processor 28, etc.) of the data processing apparatus 12, or may be configured by the specific processing unit 290, the specific processing program 56, the data generation model 58, and the like.

Furthermore, the connection management unit is realized on the server. This unit provides an interface for the customer to manage the API connection to their own natural language processing model. The customer can set permission or denial for a specific application to use their own NLP model. For example, by allowing a specific shopping app to use their NLP model, the app can suggest products based on the customer's past purchase history and preferences. Also, by allowing a health management app to use their NLP model, the customer can receive advice according to their individual health condition and lifestyle. Furthermore, by granting permission to a travel planning app, suggestions for travel destinations and optimization of schedules are performed based on the customer's past travel history and preferences.

The connection management unit may perform token authentication based on a standard protocol such as OAuth 2.0 for an API request from an external application, and may provide a sandbox environment that strictly controls a data range (Scope) accessible to each application. For example, upon receiving an inference request from an external app, the connection management unit may expand the customer's individual model (difference parameters) in a temporary memory space (Enclave), return only an inference result, and block direct access to parameters of the model itself or learning source data. The connection management unit may include an anomaly detection module that monitors a request pattern via the API, and upon detecting an access with a frequency or pattern different from usual (for example, an attempt to extract a large amount of personal information in a short time), immediately blocks the API connection and transmits a warning notification to the customer's smart device 14.

The connection management unit may be configured by, for example, the computer 22 (processor 28, etc.) of the data processing apparatus 12, or may be configured by the specific processing unit 290, the specific processing program 56, the data generation model 58, and the like.

In this way, a personalized experience according to the individual needs of the customer can be provided and the problems of personal information protection and privacy can be addressed. The customer can enjoy more convenient and efficient services while controlling how their information is used.

### (System Configuration)

The system includes a base learning unit, a data collection unit, an individual learning unit, and a connection management unit. The base learning unit is realized on a server and holds a natural language processing model that has been pre-trained using a wide range of text datasets. This model is trained using data collected from various sources such as news articles, encyclopedias, and literary works, and has the ability to understand general grammatical structures and the meanings of vocabulary. For example, it can learn timely terms and expressions from news articles, specialized knowledge and definitions from encyclopedias, and diverse writing styles and emotional expressions from literary works. This provides the model with a foundation for understanding diverse contexts and expressions.

The data collection unit is realized on a terminal and, with the customer's permission, collects text data from messaging apps, email clients, SNS apps, and the like. For example, in a messaging app, this includes daily conversations with friends and family, business communications, and exchange of opinions in group chats. From the email client, business email exchanges, sending and receiving of personal emails, and newsletter subscription history are collected. From the SNS app, comments posted by the customer, reactions to others' posts, history of likes and shares, and the activities of followed accounts are included. This data serves as an important source of information for reflecting the customer's language usage patterns and communication style in detail.

The individual learning unit is realized on the server and builds a natural language processing model for each customer using the collected data. This unit uses machine learning algorithms to learn the customer's language usage patterns, preferences, interests, values, and the like. For example, it identifies phrases and words frequently used by the customer and analyzes their frequency of use and context. It also analyzes patterns of reactions and emotional expressions to specific topics and incorporates the customer's emotional tendencies into the model. Furthermore, it generates a model for predicting future behavior and preferences based on the customer's past behavior history. As a result, an individual natural language processing model for the customer is generated, which has the ability to anticipate what the customer is “likely to think”. This model provides a personalized experience according to the customer's needs based on the customer's past behavior and language patterns.

The connection management unit is realized on the server and provides an interface for the customer to manage the API connection to their own natural language processing model. The customer can set permission or denial for a specific application to use their own NLP model. For example, by allowing a specific shopping app to use their NLP model, the app can suggest products based on the customer's past purchase history and preferences. Also, by allowing a health management app to use their NLP model, the customer can receive advice according to their individual health condition and lifestyle. Furthermore, by granting permission to a travel planning app, suggestions for travel destinations and optimization of schedules are performed based on the customer's past travel history and preferences.

Specific examples of prompt sentences to be read into the generative AI include “Identify frequently used phrases based on the customer's conversation history in the messaging app, and analyze their frequency of use and context” and “Analyze the patterns of emotional expression based on the customer's posting history on SNS, and incorporate the customer's emotional tendencies into the model”. These prompt sentences give instructions for extracting information necessary for the system to provide a personalized experience according to the individual needs of the customer and reflecting it in the model.

### (Implementation Steps)

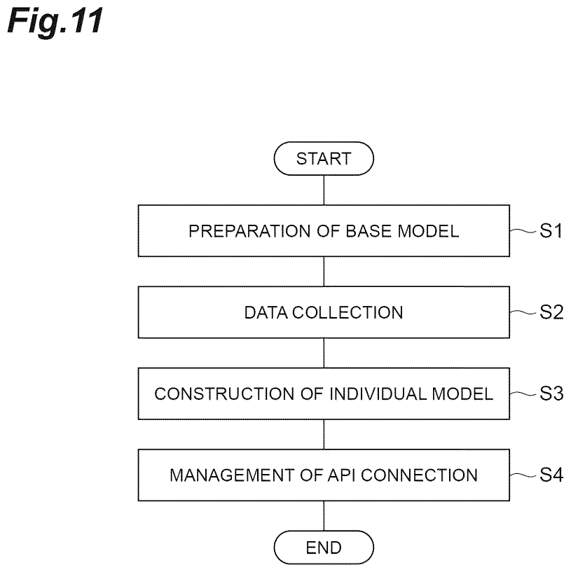

### Step 1: Preparation of Base Model (Refer to Step S1 of FIG. 11)

First, a natural language processing model that has been pre-trained using a wide range of text datasets is prepared on a server. This model is trained using data collected from various sources such as news articles, encyclopedias, and literary works, and has the ability to understand general grammatical structures and the meanings of vocabulary. This provides the model with a foundation for understanding diverse contexts and expressions.

### Step 2: Data Collection (Refer to Step S2 of FIG. 11)

Next, with the customer's permission, text data is collected from messaging apps, email clients, SNS apps, and the like on a terminal. For example, in a messaging app, this includes daily conversations with friends and family, business communications, and exchange of opinions in group chats. From the email client, business email exchanges, sending and receiving of personal emails, and newsletter subscription history are collected. From the SNS app, comments posted by the customer, reactions to others' posts, history of likes and shares, and the activities of followed accounts are included.

### Step 3: Building of Individual Model (Refer to Step S3 of FIG. 11)

Using the collected data, a natural language processing model for each customer is built on the server. In this step, machine learning algorithms are used to learn the customer's language usage patterns, preferences, interests, values, and the like. For example, it identifies phrases and words frequently used by the customer and analyzes their frequency of use and context. It also analyzes patterns of reactions and emotional expressions to specific topics and incorporates the customer's emotional tendencies into the model. As a step using a generative AI, specific examples of prompt sentences include “Identify frequently used phrases based on the customer's conversation history in the messaging app, and analyze their frequency of use and context” and “Analyze the patterns of emotional expression based on the customer's posting history on SNS, and incorporate the customer's emotional tendencies into the model”.

### Step 4: Management of API Connection (Refer to Step S4 of FIG. 11)

Finally, an interface is provided on the server for the customer to manage the API connection to their own natural language processing model. The customer can set permission or denial for a specific application to use their own NLP model. For example, by allowing a specific shopping app to use their NLP model, the app can suggest products based on the customer's past purchase history and preferences. Also, by allowing a health management app to use their NLP model, the customer can receive advice according to their individual health condition and lifestyle. Furthermore, by granting permission to a travel planning app, suggestions for travel destinations and optimization of schedules are performed based on the customer's past travel history and preferences.

### (Specific Use Case)

For example, how the system functions will be described through a messaging app, an email client, and an SNS app that a certain user uses on a daily basis. The user frequently communicates with friends and family and also conducts business interactions on the messaging app. This records the user's language usage patterns and communication style in detail. In the email client, business email exchanges and sending and receiving of personal emails are performed, and newsletter subscription history is also included. In the SNS app, comments posted by the user, reactions to others' posts, history of likes and shares, and the activities of followed accounts are included.

This data is collected by the data collection unit and sent to the individual learning unit. The individual learning unit uses machine learning algorithms to learn the user's language usage patterns, preferences, interests, and values, and builds an individual natural language processing model. This model has the ability to anticipate what the user is “likely to think” and provides a personalized experience according to the user's needs based on the user's past behavior and language patterns.

For example, when the user uses a shopping app, products based on past purchase history and preferences are suggested through this natural language processing model. In a health management app, advice according to the user's health condition and lifestyle is provided. In a travel planning app, suggestions for travel destinations and optimization of schedules are performed based on past travel history and preferences.

Specific examples of prompt sentences to be read into the generative AI include “Identify frequently used phrases based on the user's conversation history in the messaging app, and analyze their frequency of use and context” and “Analyze the patterns of emotional expression based on the user's posting history on SNS, and incorporate the user's emotional tendencies into the model”. These prompt sentences give instructions for extracting information necessary for the system to provide a personalized experience according to the individual needs of the user and reflecting it in the model.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

This system is intended to provide personalized care to an individual receiving nursing care, and includes a data collection unit, an individual learning unit, and a connection management unit.

The data collection unit, with the permission of the individual receiving nursing care, collects various data in daily life. This data includes daily conversations through a voice assistant, vital signs from a health monitoring device, amount of exercise from an activity tracker, meal records, medication history, and the like. For example, through a voice assistant, phrases and words that the individual uses on a daily basis are recorded to grasp their communication style. This allows for a detailed analysis of the individual's language usage patterns and facilitates smoother communication. From the health monitoring device, vital signs such as heart rate, blood pressure, and body temperature are periodically measured to continuously monitor the individual's health condition. For example, if an abnormal fluctuation in heart rate or a sudden rise in blood pressure is detected, an alert can be promptly issued to notify caregivers or medical institutions. The activity tracker is used to record the individual's daily amount of exercise and analyze activity trends. For example, by recording the number of steps and the frequency of exercise, it is possible to grasp the individual's exercise habits and propose an appropriate exercise plan. The meal record is useful for proposing meals that take into account the individual's nutritional balance and allergy information. For example, if a specific nutrient is deficient, ingredients or recipes to supplement it can be proposed.

The individual learning unit builds a natural language processing model of the individual receiving nursing care using the collected data. This model learns the individual's language usage patterns, health condition, and lifestyle habits, and generates an individual care plan. For example, if the individual has an allergy to a specific food, meal suggestions are made based on that information. It also has a function to remind the individual of the time and amount of medication, supporting medication management. For example, when it is time to take medication, the voice assistant can issue a reminder to prompt the individual to take the medication. Furthermore, to optimize daily activities, it can suggest appropriate timing for exercise and rest. For example, if the individual's activity level is low, it can suggest light exercise, and if the activity level is high, it can encourage rest, thereby maintaining a healthy lifestyle. The generated care plan is dynamically updated according to the individual's health condition and lifestyle habits, so it is always possible to provide optimal care.

The connection management unit provides an interface for sharing information with medical institutions and nursing care service providers as needed, while protecting the individual's privacy. The individual can control how their information is used and permit or deny the sharing of information with specific service providers. For example, by allowing a specific medical institution to share their health data, the medical institution can provide more appropriate diagnosis and treatment. Also, by sharing the individual's care plan with a nursing care service provider, more effective nursing care services can be provided. Furthermore, based on the individual's consent, information can also be shared with family members and trusted third parties, enabling a prompt response in case of an emergency.

In this way, the system can provide personalized nursing care support according to individual needs and improve the quality of nursing care. By providing a care plan based on the individual's health condition and lifestyle habits, it is possible to improve the quality of life of the individual receiving nursing care and to reduce the burden on caregivers and medical institutions.

### (System Configuration)

The system includes a data collection unit, an individual learning unit, and a connection management unit. The data collection unit, with the permission of the individual receiving nursing care, collects various data in daily life. This data includes daily conversations through a voice assistant, vital signs from a health monitoring device, amount of exercise from an activity tracker, meal records, medication history, and the like. Through a voice assistant, phrases and words that the individual uses on a daily basis are recorded to grasp their communication style. This allows for a detailed analysis of the individual's language usage patterns and facilitates smoother communication. From the health monitoring device, vital signs such as heart rate, blood pressure, and body temperature are periodically measured to continuously monitor the individual's health condition. For example, if an abnormal fluctuation in heart rate or a sudden rise in blood pressure is detected, an alert can be promptly issued to notify caregivers or medical institutions. The activity tracker is used to record the individual's daily amount of exercise and analyze activity trends. For example, by recording the number of steps and the frequency of exercise, it is possible to grasp the individual's exercise habits and propose an appropriate exercise plan. The meal record is useful for proposing meals that take into account the individual's nutritional balance and allergy information. For example, if a specific nutrient is deficient, ingredients or recipes to supplement it can be proposed.

The individual learning unit builds a natural language processing model of the individual receiving nursing care using the collected data. This model learns the individual's language usage patterns, health condition, and lifestyle habits, and generates an individual care plan. For example, if the individual has an allergy to a specific food, meal suggestions are made based on that information. It also has a function to remind the individual of the time and amount of medication, supporting medication management. For example, when it is time to take medication, the voice assistant can issue a reminder to prompt the individual to take the medication. Furthermore, to optimize daily activities, it can suggest appropriate timing for exercise and rest. For example, if the individual's activity level is low, it can suggest light exercise, and if the activity level is high, it can encourage rest, thereby maintaining a healthy lifestyle. The generated care plan is dynamically updated according to the individual's health condition and lifestyle habits, so it is always possible to provide optimal care.

The connection management unit provides an interface for sharing information with medical institutions and nursing care service providers as needed, while protecting the individual's privacy. The individual can control how their information is used and permit or deny the sharing of information with specific service providers. For example, by allowing a specific medical institution to share their health data, the medical institution can provide more appropriate diagnosis and treatment. Also, by sharing the individual's care plan with a nursing care service provider, more effective nursing care services can be provided. Furthermore, based on the individual's consent, information can also be shared with family members and trusted third parties, enabling a prompt response in case of an emergency.

Specific examples of prompt sentences to be read into the generative AI include “Identify frequently used phrases based on the conversation history of the individual receiving nursing care in the voice assistant, and analyze their frequency of use and context” and “Evaluate the individual's health condition based on data from the health monitoring device, and set an alert for when an abnormality is detected”. These prompt sentences give instructions for extracting information necessary for the system to provide personalized care according to individual needs and reflecting it in the model.

### (Implementation Steps)

### Step 1: Preparation for Data Collection

First, with the permission of the individual receiving nursing care, preparations for data collection are made. In this step, devices such as a voice assistant, a health monitoring device, and an activity tracker are set up to prepare an environment for collecting data in the individual's daily life. This makes it possible to acquire detailed data regarding the individual's communication style, health condition, and lifestyle habits.

### Step 2: Data Collection

Next, the data collection unit collects data such as daily conversations through a voice assistant, vital signs from a health monitoring device, amount of exercise from an activity tracker, meal records, and medication history. For example, the voice assistant records phrases and words that the individual uses on a daily basis, and the health monitoring device periodically measures heart rate and blood pressure. The activity tracker records the number of steps and the frequency of exercise, and the meal record is used to grasp the nutritional balance.

### Step 3: Building of Individual Model

Using the collected data, the individual learning unit builds a natural language processing model of the individual receiving nursing care. This model learns the individual's language usage patterns, health condition, and lifestyle habits, and generates an individual care plan. As a step using a generative AI, specific examples of prompt sentences include “Identify frequently used phrases based on the conversation history of the individual receiving nursing care in the voice assistant, and analyze their frequency of use and context” and “Evaluate the individual's health condition based on data from the health monitoring device, and set an alert for when an abnormality is detected”.

### Step 4: Provision of Care Plan

The care plan generated by the individual learning unit is provided to caregivers and medical institutions. This care plan includes meal suggestions, medication reminders, and suggestions for appropriate timing of exercise and rest. For example, if a specific nutrient is deficient, ingredients or recipes to supplement it are proposed, and a reminder is issued when it is time to take medication.

### Step 5: Information Sharing and Privacy Management

The connection management unit provides an interface for sharing information with medical institutions and nursing care service providers as needed, while protecting the individual's privacy. The individual can control how their information is used and permit or deny the sharing of information with specific service providers. This ensures that the individual's health data is properly managed and that a prompt response is possible in an emergency.

### (Specific Use Case)

For example, a situation is assumed where an elderly person receives nursing care at home. This elderly person uses a voice assistant in their daily life and wears a health monitoring device. The voice assistant records the elderly person's language usage patterns through daily conversations, and the health monitoring device periodically measures vital signs such as heart rate, blood pressure, and body temperature. Furthermore, an activity tracker records the elderly person's number of steps and amount of exercise, and a meal record is used to grasp the nutritional balance.

This system builds a natural language processing model of the elderly person using the collected data. This model learns the elderly person's language usage patterns, health condition, and lifestyle habits, and generates an individual care plan. For example, if the elderly person has an allergy to a specific food, meal suggestions are made based on that information. It has a function to remind the person of the time and amount of medication, supporting medication management. To optimize daily activities, it can suggest appropriate timing for exercise and rest.

Specific examples of prompt sentences to be read into the generative AI include “Identify frequently used phrases based on the elderly person's conversation history in the voice assistant, and analyze their frequency of use and context” and “Evaluate the elderly person's health condition based on data from the health monitoring device, and set an alert for when an abnormality is detected”. These prompt sentences give instructions for extracting information necessary for the system to provide personalized care according to the individual needs of the elderly person and reflecting it in the model.

In this way, the system can provide personalized nursing care support according to the individual needs of the elderly person and improve the quality of nursing care. By providing a care plan based on the elderly person's health condition and lifestyle habits, it is possible to improve the quality of life of the elderly person and to reduce the burden on caregivers and medical institutions.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

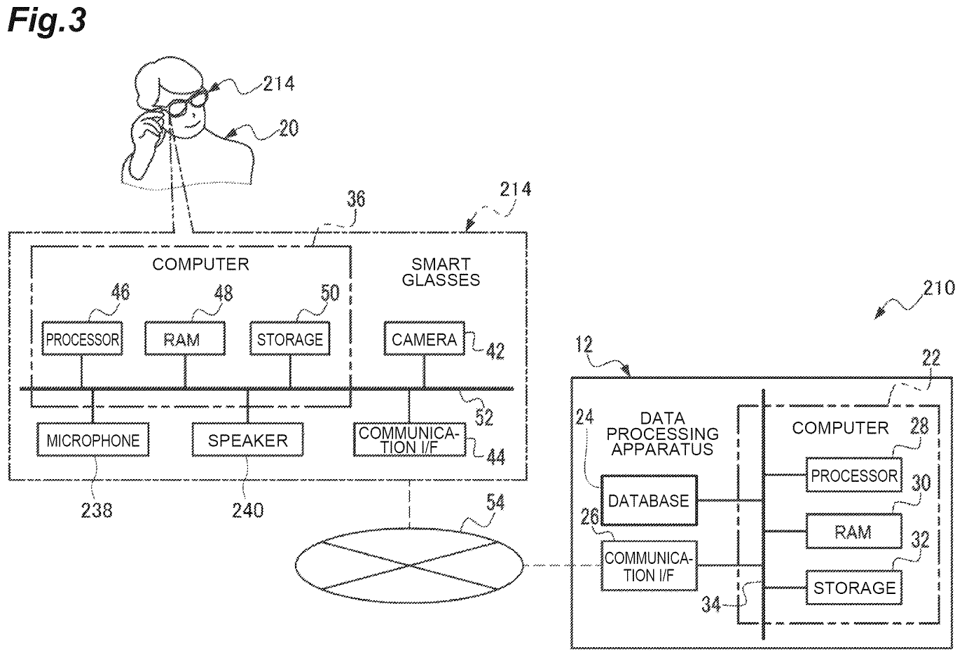

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

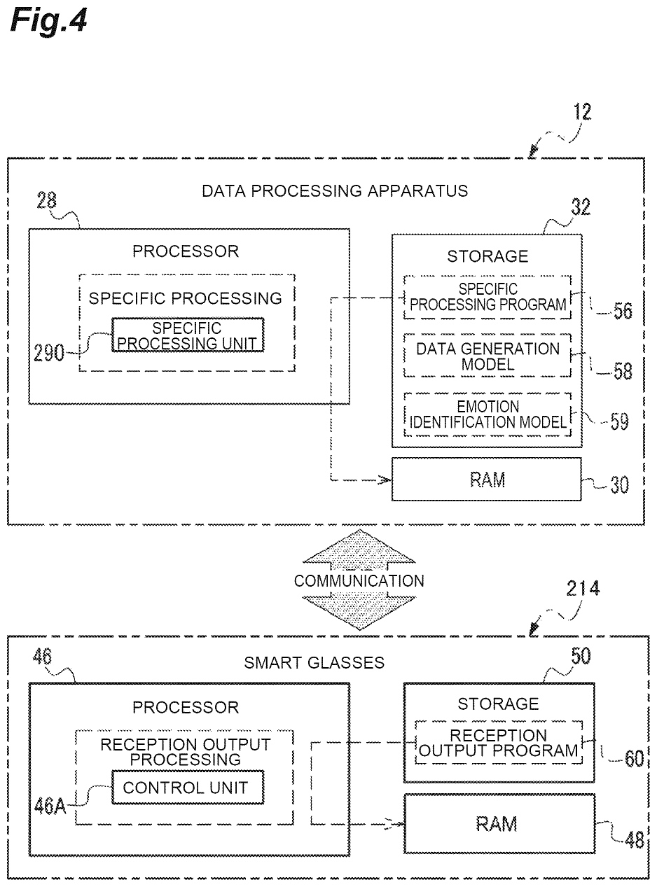

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

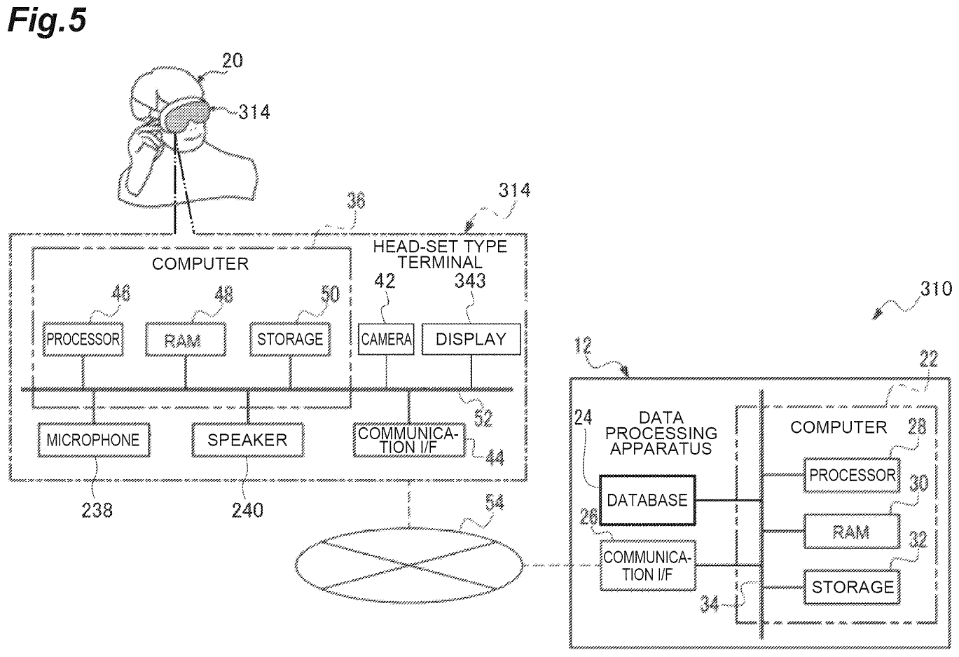

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

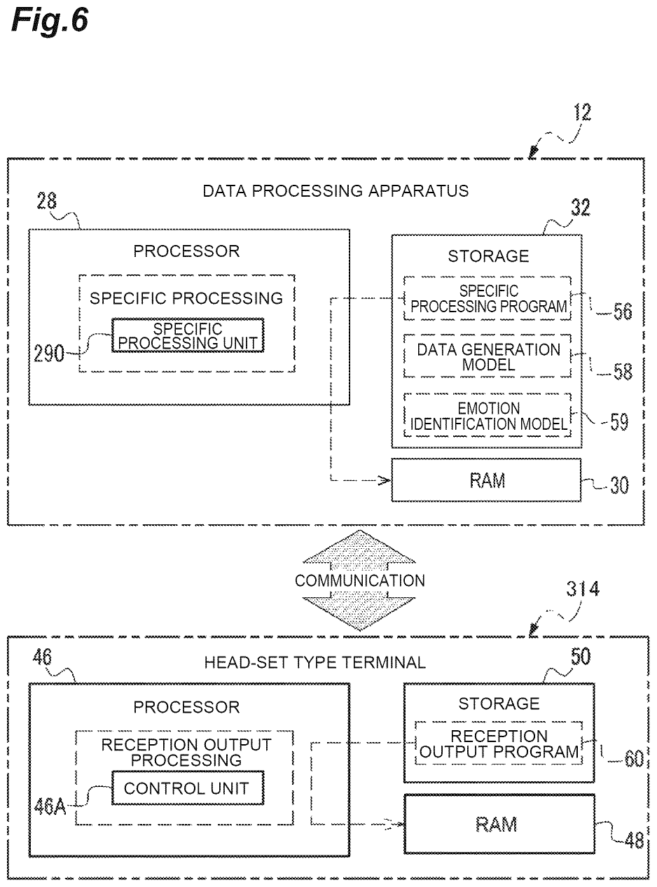

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

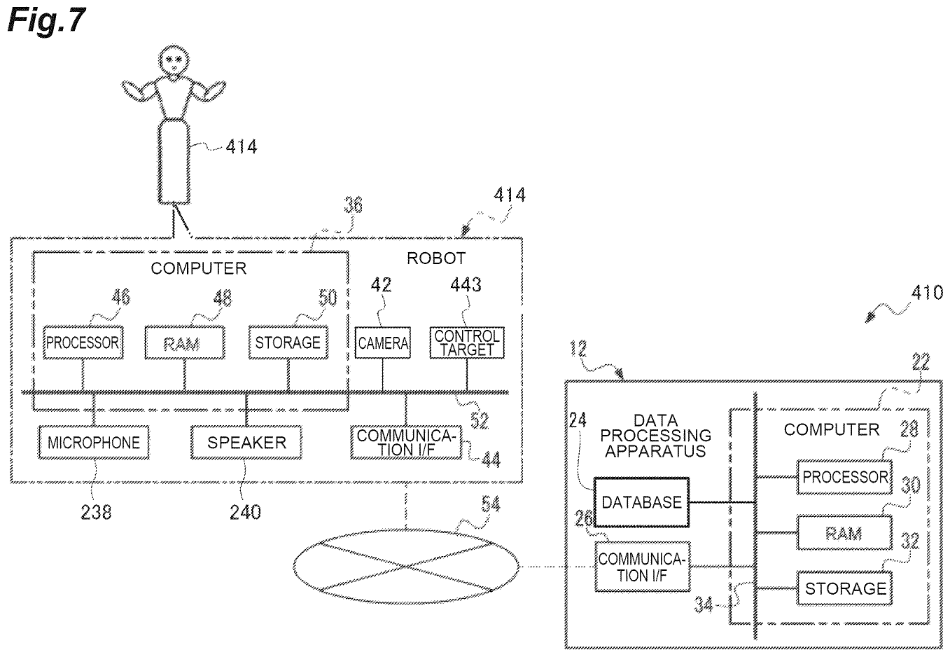

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

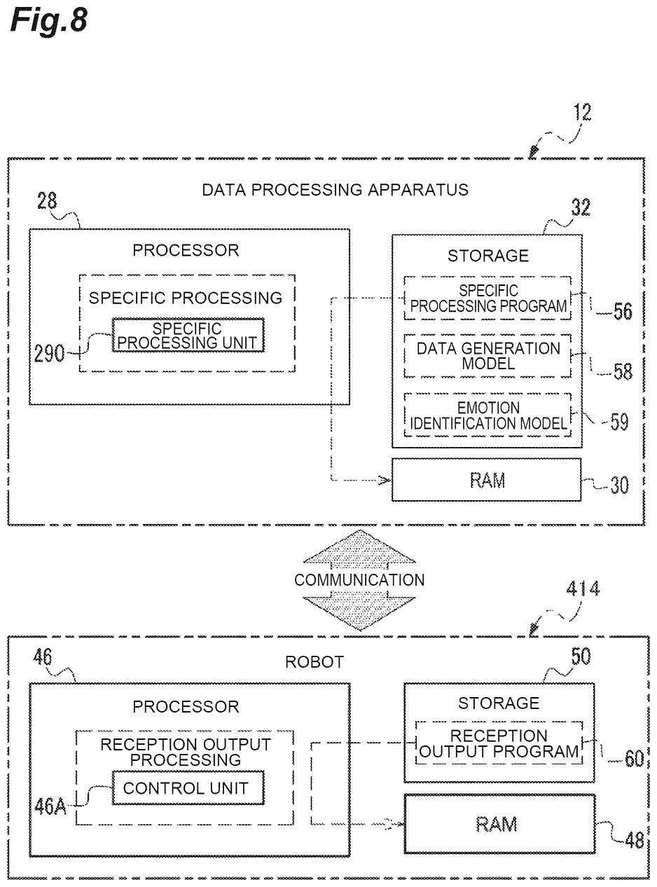

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

An estimation result of an emotion by the emotion identification model 59 is not limited to a mere output of information, but may be converted as a control parameter of a physical device. For example, in the robot 414 (see FIG. 8), when the identified emotion is “anger” or “impatience”, the specific processing unit 290 may perform safety control to prevent sudden operation by increasing a damping coefficient that suppresses operation speed when generating a control signal to a motor (actuator) of the robot. In the case of “joy”, a luminance pattern or a blinking frequency of an LED may be changed to a specific “pleasant” pattern. In this way, the system has a configuration in which a result of natural language processing does not remain in cyberspace but is directly converted into a specific operation control signal (PWM signal, etc.) of physical hardware (motor, LED, speaker).

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

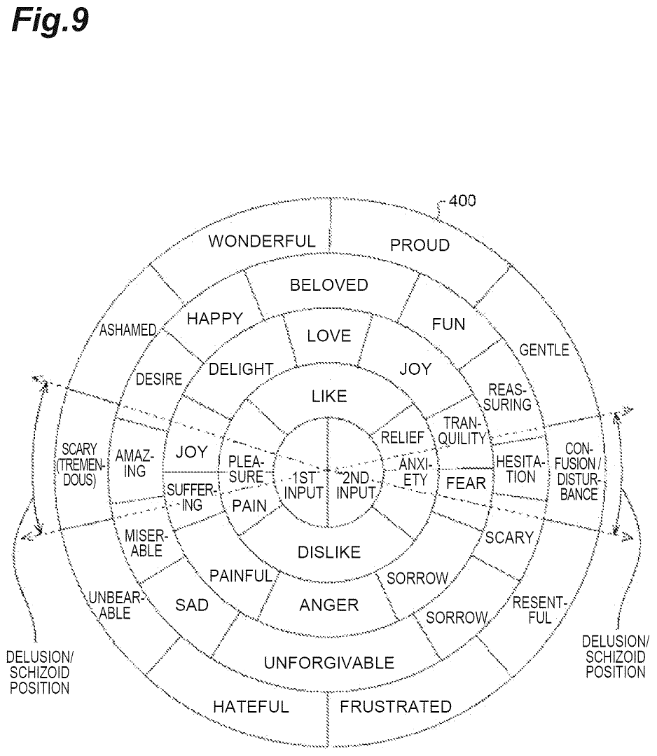

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

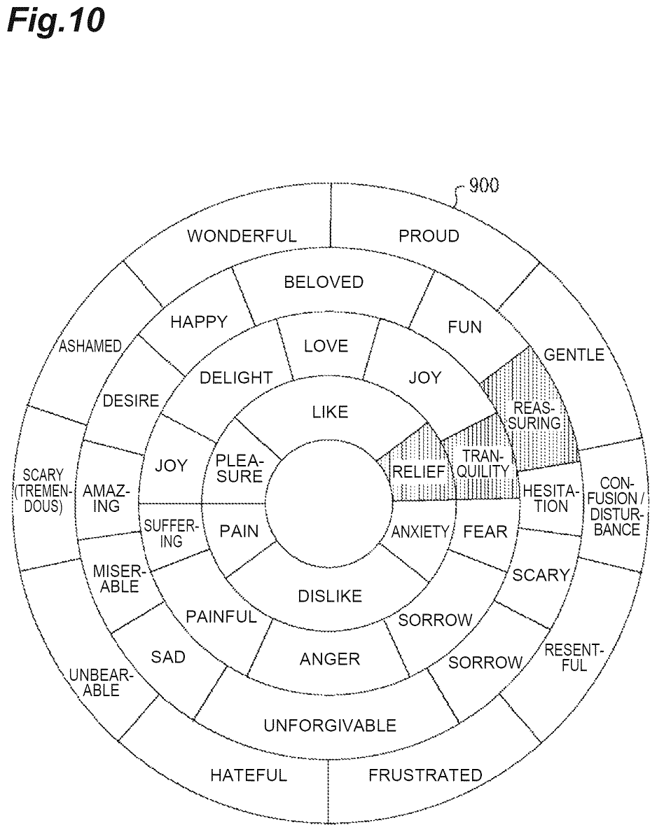

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

Construction and update processing of the natural language processing model in the present disclosure include calculations in a vector space of millions to billions of dimensions, and may be executed in parallel for real-time data streams from a large number of customers. Such processing is theoretically and practically impossible to perform as a human mental activity (Mental Process), and is realized for the first time by an organic combination of hardware resources specialized for parallel calculation such as a GPU (Graphics Processing Unit) or a TPU (Tensor Processing Unit) and the specific memory management structure described above (base model sharing and difference parameter management). Thereby, it is possible to solve the trade-off problem of immediate learning of individual subtle language nuances and efficiency of server calculation resources, which could not be achieved by conventional technology.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a data collection unit, an individual learning unit, and a connection management unit. The data collection unit, with the permission of the individual receiving nursing care, collects data such as conversations through a voice assistant in daily life, vital signs from a health monitoring device, amount of exercise from an activity tracker, meal records, and medication history. The individual learning unit uses the collected data to learn the individual's language usage patterns, health condition, and lifestyle habits, and builds an individual natural language processing model. This model has the ability to make meal suggestions according to the individual's health condition, provide medication reminders, and optimize daily activities. The connection management unit provides an interface for sharing information with medical institutions and nursing care service providers as needed, while protecting the individual's privacy.

In some examples, the data collection unit has a function of identifying an individual's language usage patterns from daily conversations through a voice assistant and analyzing frequently used phrases and words. This makes it possible to grasp the individual's communication style in detail and reflect it in the individual natural language processing model. Furthermore, it is provided with a function of evaluating the individual's health condition based on vital signs from a health monitoring device and issuing an alert promptly when an abnormality is detected.

In some examples, the individual learning unit generates a personalized care plan according to the individual's health condition and lifestyle habits using the collected data. This care plan includes meal suggestions, medication reminders, and suggestions for appropriate timing of exercise and rest, and is further provided with an alert function for prompt response in case of an emergency. The connection management unit allows the individual to control how their information is used and to permit or deny the sharing of information with specific service providers.

An example system for providing a personalized application programming interface experience may include circuitry. The circuitry may be configured to: build a natural language processing model for each customer based on data in which interactions on a mobile phone of the customer are collected; and manage an application programming interface connection to the natural language processing model of the customer by the customer.

In some examples, the data may include text data including a conversation in a messaging app, an email, and a post on a social networking service.

In some examples, managing the application programming interface connection may set permission or denial for a specific application.

An example method of providing a personalized application programming interface experience may include: building a natural language processing model for each customer based on data in which interactions on a mobile phone of the customer are collected; and managing an application programming interface connection to the natural language processing model of the customer by the customer.

What is claimed is:

1. A system for providing a personalized application programming interface experience, the system comprising circuitry:
wherein the circuitry is configured to:
build a natural language processing model for each customer based on data in which interactions on a mobile phone of the customer are collected; and
manage an application programming interface connection to the natural language processing model of the customer by the customer.

2. The system according to claim 1, wherein the data includes text data including a conversation in a messaging app, an email, and a post on a social networking service.

3. The system according to claim 1, wherein managing the application programming interface connection sets permission or denial for a specific application.

4. A method of providing a personalized application programming interface experience, the method comprising:
building a natural language processing model for each customer based on data in which interactions on a mobile phone of the customer are collected; and
managing an application programming interface connection to the natural language processing model of the customer by the customer.
